(19) United States
(12) Patent Application Publication
(10) Pub. No.: US 2016/0043750 A1
(43) Pub. Date: Feb. 11, 2016

(54) Wearable Multi-Band Wireless Transceiver

(71) Applicant: Malcolm Larry Borlenghi, Westfield, NJ (US)

(72) Inventor: Malcolm Larry Borlenghi, Westfield, NJ (US)

(21) Appl. No.: 14/816,533

(22) Filed: Aug. 3, 2015

Related U.S. Application Data
(63) Continuation-in-part of application No. 14/456,469, filed on Aug. 11, 2014, now Pat. No. 9,129,503.

(51) Int. Cl. H04B 1/00

(52) U.S. Cl. CPC H04B 1/0057

(57) ABSTRACT

A wearable wireless transceiver is configured for multi-band operation employing one or more wireless protocols, including cellular, WiFi, WiMAX, ultra-wideband (UWB), Bluetooth and/or Zigbee. The wearable wireless transceiver comprises a housing unit and one or more wearable attachment means. The housing unit contains one or more wireless transceiver modules, one or more high frequency (greater than 1000 MHz) antennas, and one or more diplex filters. The wearable attachment means contains one or more low frequency (equal to or less than 1000 MHz) antennas. The diplex filter(s) segregate incoming and outgoing signals into the high and low frequency bands and direct such signals to the corresponding antenna(s).

### REFERENCE TO RELATED APPLICATIONS

This application is a continuation-in-part of U.S. application Ser. No. 14/456,469, filed Aug. 11, 2014, which is a continuation-in-part of U.S. application Ser. No. 13/694,211, filed Nov. 7, 2012, both of which disclosures are incorporated herein by reference.

### FIELD OF INVENTION

The present invention generally relates to the field of wireless communications, and more particularly relates to multi-band wireless transceivers.

### BACKGROUND OF THE INVENTION

The capability of transmitting and receiving in multiple frequency bands, or multi-band operation, is advantageous in terms of transmit/receive diversity and carrier aggregation. Designing wearable devices for multi-band operation is challenging, however, because the unit housing the device often affords a very limited footprint in which to locate low-band antennas, which optimally must be substantially larger/longer than high-band antennas.

One approach, as disclosed in our U.S. application Ser. No. 14/456,469, is to locate the low-band antenna(s) externally from the housing unit within the more extensive footprint of a wearable attachment means, such as a wristband. One or more diplex filters are used to segregate incoming and outgoing signals by frequency range and direct the low frequency bands to the external antenna(s). The present invention generalizes upon that approach to apply it to any type of wireless transceiver and to a variety of wearable attachment means.

### SUMMARY OF THE INVENTION

The present invention is a wearable wireless transceiver, which is configured for multi-band operation employing one or more wireless prototcols, including cellular, WiFi, WiMAX, ultra-wideband (UWB), Bluetooth and/or Zigbee. As used herein “wearable” means capable of being attached or secured to one or more parts of the human body in a manner than does not impair normal bodily movements.

The wearable wireless transceiver is attached or secured to the wearer's body by a wearable attachment means, which means may include, without limitation, one or more of the following: straps, cords, wristbands, armbands, headbands, visors, caps, waistbands, belts, ankle bands, leg bands, neckbands, necklaces, bracelets, neckties, rings, pins, brooches, pendants, earrings, eyeglasses and/or goggles.

The wearable wireless transceiver comprises a housing unit and one or more wearable attachment means. The housing unit contains one or more wireless transceiver modules, one or more high frequency (greater than 1000 MHz) antennas, and one or more diplex filters. The wearable attachment means contains one or more low frequency (equal to or less than 1000 MHz) antennas. The diplex filter(s) segregate incoming and outgoing signals into the high and low frequency bands and direct such signals to the corresponding antenna(s).

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1 is a schematic diagram of one exemplary embodiment of the present invention; and

FIG. 2 is a perspective view of an exemplary wristband embodiment of the present invention.

### DETAILED DESCRIPTION OF THE PREFERRED EMBODIMENT

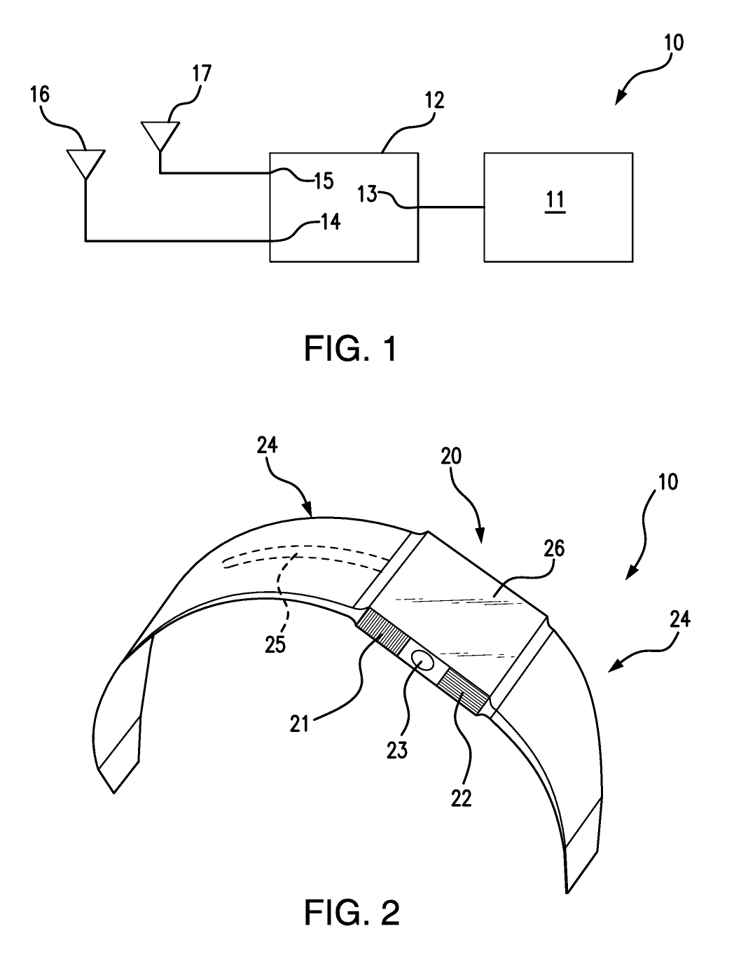

Referring to FIG. 1, one exemplary embodiment of the present invention 10 comprises a wireless module 11 electrically connected to a diplex filter 12 through a filter input 13. Depending on the frequency of the input signal, the diplex filter 12 sends it through a low frequency output 14 to a low band antenna 16, or through a high frequency output 15 to a high band antenna 17.

Referring to FIG. 2, an exemplary wristband embodiment of the present invention 10 comprises a housing unit 20, which contains a display screen 26, microphone 21, speaker 22 and control panel 23. Within the wristband 24 is contained the low band antenna 25.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A wearable wireless transceiver, comprising:
a housing unit, containing one or more multi-band wireless transceiver modules, one or more high frequency antennas, and one or more diplex filters; and
one or more wearable attachment means, containing one or more low frequency antennas, wherein the diplex filter(s) are configured to segregate incoming and outgoing wireless signals into high frequency bands and low frequency bands and to direct the high frequency bands to the high frequency antenna(s) and the low frequency bands to the low frequency antenna(s).

2. The wearable wireless transceiver of claim 1, wherein the wearable attachment means comprises a wristband, and wherein the housing unit further comprises a speaker, a microphone, and a display screen.
